(19) United States
(12) Patent Application Publication
(10) Pub. No.: US 2014/0197937 A1
(43) Pub. Date: Jul. 17, 2014

(54) WEARABLE DEVICE FOR NONINVASIVE TACTILE STIMULATION

(71) Applicants: Ruey-Song Huang, San Diego, CA (US); Martin I. Sereno, London (GB)

(72) Inventors: Ruey-Song Huang, San Diego, CA (US); Martin I. Sereno, London (GB)

(73) Assignee: THE REGENTS OF THE UNIVERSITY OF CALIFORNIA, Oakland, CA (US)

(21) Appl. No.: 14/238,823

(22) PCT Filed: Aug. 15, 2012
(86) PCT No.: PCT/US2012/050980

§ 371 Date: Feb. 13, 2014

Related U.S. Application Data
(60) Provisional application No. 61/524,717, filed on Aug. 17, 2011.

(51) Int. Cl. G08B 6/00

(52) U.S. Cl. CPC G08B 6/00
USPC 340/407.1

(57) ABSTRACT

A wearable tactile stimulation device can include a facial mask, an air-suit, and a pair of gloves. A wearable tactile stimulation device can include integrated conduits and nozzles configured to deliver tactile stimulation to portions of a users face, hands, and/or body. The tactile stimulation can be delivered via puffs of air transmitted through the conduits and nozzles. A controller can be configured to control tactile stimulation by controlling the generation and delivery of puffs of air. The puffs can be delivered individually, or in combination.

### CROSS-REFERENCE TO RELATED APPLICATIONS

This application claims the benefit of U.S. Provisional Patent Application No. 61/524,717, entitled WEARABLE DEVICE FOR NON-INVASIVE TACTILE STIMULATION, filed Aug. 17, 2011, the disclosure of which is incorporated by reference herein in its entirety.

### STATEMENT OF GOVERNMENT SUPPORT

This invention was made with government support under Grant Number 5R01MH081990 awarded by the National Institutes of Health. The government has certain rights in the invention.

### BACKGROUND OF THE INVENTION

1. Field of the Invention

The specification refers to the field of tactile stimulation devices.

2. Description of the Related Art

Tactile stimulation can be used to treat medical conditions, study the brain, create sensations, or pursue other purposes. Delivery of sensory motor stimulation to the patients is often performed meticulously by healthcare professionals, which is very laborious and time consuming.

Some more recent devices use air to stimulate tactile sensation. Such prior systems can only accomplish very limited tasks. These devices rely on solenoid valves to deliver brief puffs of air into plastic tubes connected to adjustable nozzles aimed at, for example, 12 locations around the subject's face.

### SUMMARY OF THE INVENTION

Some embodiments relate to a wearable module that can direct air to a subject's body. The wearable module can include a plurality of conduits and a plurality of openings attached to the conduits, which opening can receive pressurized air from the conduits and direct the pressurized air to a portion of the subject's body, which air can be selectively delivered to a subset of the openings. In some aspects of all of the embodiments discussed in this paragraph, the wearable module can further include a viewing area, a conduit can be connected to one of the plurality of openings, and/or a conduit can be connected to more than one of the plurality of openings. In some aspects of all of the embodiments of this paragraph, the wearable module can include a connector that allows connection of the conduits to an air supply system. In some aspects of the embodiments of this paragraph, the viewing area of the wearable module can include a lens. In some aspects of the previous embodiment of this paragraph, the lens can alter the subject's sight. In some aspects of some of the previous embodiments of this paragraph, the viewing area includes a first lens and a second lens, and in some aspects of the previous embodiments of this paragraph, the first lens and the second lens can provide a stereoscopic effect. In some aspects of all of the embodiments of this paragraph, the wearable module can be a mask, goggles, glasses, and/or a hat or helmet. In some aspects of all of the embodiments of this paragraph, the wearable module can be fluidly connected to an air source, which air source can be, for example, controlled by a computer. In some aspects of the previous embodiment of this paragraph, the wearable module can be fluidly connected to the air source via a channel controller. In some aspects of all of the previous embodiments of this paragraph, the wearable module can include a support feature, which can be, for example, a bridge, a nose pad, and/or a temple or band.

Some embodiments relate to an entertainment system that can include, for example, an entertainment source, an air source, and a wearable module in fluid connection with the air source and that can receive air from the air source and direct air to a portion of a subject's body. In some aspect of the previous embodiment of this paragraph, the wearable module can include a plurality of openings. In some aspects of all of the previous embodiments of this paragraph, the openings can receive pressurized air from the wearable module and direct the pressurized air to a portion of the subject's body. In some aspects of all of the previous embodiments of this paragraph, the wearable module can be worn over a subject's eyes. In some aspects of all of the previous embodiments of this paragraph, the wearable module includes a viewing area, which can, for example, be a lens. In some aspect of the previous embodiment of this paragraph, the lens can alter the subject's sight. In some aspects of some of the embodiments of this paragraph, the viewing area can include a first lens and a second lens, which can, in some embodiments, provide a stereoscopic effect. In some aspects of all of the previous embodiments of this paragraph, the wearable module further includes a support feature. In some aspects of all of the previous embodiments of this paragraph, the entertainment system can further include a seat that can, for example, be associated with a connector array connecting the wearable module with the air source. In some aspects of all of the previous embodiments of this paragraph, the air source can alter the temperature of the air. In some aspects of all of the previous embodiments of this paragraph, the air source can heat the air. In some aspects of all of the previous embodiments of this paragraph, the air source can cool the air. In some aspects of all of the previous embodiments of this paragraph, the air source can alter the humidity of the air. In some aspects of all of the previous embodiments of this paragraph, the air source can alter the composition of the air. In some aspects of all of the previous embodiments of this paragraph, the air source can add a scent to the air. In some aspects of all of the previous embodiments of this paragraph, the entertainment source can be, for example, a movie screen, a computer, a speaker, a videogame console, and/or a television. In some aspects of all of the previous embodiments of this paragraph, the air source can provide air to stimulate sensations the subject would experience in the environment represented by the entertainment.

Some embodiments relate to a wearable tactile stimulation device that can include a facial mask shaped and configured for placement on a human face including a plurality of openings which can deliver tactile stimulation to a portion of the human face, an air-suit configured for placement on a human body and including a plurality of openings, which openings can deliver tactile stimulation to a portion of the human body, a first glove shaped and configured to fit a first human hand and including a plurality of openings, which openings can deliver tactile stimulation to a portion of the first human hand, a second glove shaped and configured to fit a second human hand and including a plurality of openings, which openings can deliver tactile stimulation to a portion of the second human hand, a compressed air source, and a computer controller including stored instructions that control release of compressed air to at least one of the conduits and openings of at least one of the facial mask, the air-suit, the first glove, or the second glove to create tactile stimulation. In some aspects of the embodiment of the previous paragraph, the air-suit comprises a gender-specific air-suit. In some aspects of all of the previous embodiments of this paragraph, the air-suit comprises a male air-suit. In some aspects of all of the previous embodiments of this paragraph, the air-suit comprises a female air-suit. In some aspects of all of the previous embodiments of this paragraph, the controller includes instructions to release compressed air to a plurality of conduits and openings in a pre-determined pattern. In some aspects of all of the previous embodiments of this paragraph, the stored instruction can direct the release of compressed air to create tactile stimulation as part of a treatment. In some aspects of all of the previous embodiments of this paragraph, the stored instructions direct the release of compressed air to create tactile stimulation in coordination with other entertainment. In some aspects of all of the previous embodiments of this paragraph, the tactile stimulation is coordinated with music, with a movie, and/or with a video game.

Some embodiments relate to a wearable tactile stimulation device that includes a wearable air receptacle configured to be worn over at least a portion of a subject's body and that receives a plurality of air delivery components which direct air to at least a portion of said wearable air receptacle, which delivery of air by the wearable air receptacle is coordinated with entertainment. In some aspects of all of the previous embodiments of this paragraph, the air delivery components include tubes in fluid communication with at least one air source. In some aspects of all of the previous embodiments of this paragraph, the at least one air source includes a source of compressed air. In some aspects of all of the previous embodiments of this paragraph, the delivery of air by the plurality of air delivery components to the at least a portion of the subject's body is controlled by a computer. In some aspects of all of the previous embodiments of this paragraph, the at least a portion of the subject's body is selected from the group consisting of at least a portion of the subject's face, at least a portion of the subject's hand, and at least a portion of the subject's torso. In some aspects of all of the previous embodiments of this paragraph, the wearable tactile stimulation device further includes a bodysuit, a glove, glasses, goggles, a hat, a helmet, a headset, a mask, a bra, a brace, a sweater, underwear, a sleeve, a glove, pants, shorts, a sock, a sandal, a shoe, a necklace, a band, and/or a guard.

Some embodiments relate to a wearable tactile stimulation device including, a facial mask shaped and configured for placement on a human face including a plurality of openings, which openings can deliver tactile stimulation to a portion of the human face, a compressed air source, and a computer controller including stored instructions that control release of compressed air to at least one of the conduits and openings of the facial mask to create tactile stimulation.

Some embodiments relate to a tactile stimulation device including an air suit configured for placement on a human body and including a plurality of openings, which openings can deliver tactile stimulation to a portion of the human body, a compressed air source, and a computer controller including stored instructions that control release of compressed air to at least one of the conduits and openings of the facial mask to create tactile stimulation.

Some embodiments relate to a wearable tactile stimulation device including a glove shaped and configured to fit a first human hand and including a plurality of openings, which openings can deliver tactile stimulation to a portion of the human hand, a compressed air source, and a computer controller including stored instructions that control release of compressed air to at least one of the conduits and openings of the facial mask to create tactile stimulation.

Some embodiments relate to a method of stimulating a portion of a subject's body including providing a wearable module proximate to a portion of the subject's body, which wearable module includes a plurality of conduits connected to a plurality of openings, and directing air through conduits to a portion of the subject's body in coordination with entertainment. In some aspects of all of the previous embodiments of this paragraph, the air can be directed through the conduits in coordination with entertainment. In some aspects of all of the previous embodiments of this paragraph, the entertainment can be a movie, a video game, music, a television broadcast, live entertainment, and or non-live entertainment.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a schematic of one embodiment of certain aspects of a wearable tactile stimulation device.

FIG. 2 depicts one embodiment of a 64-channel system wearable tactile stimulation device setup for an MRI environment.

FIG. 3 depicts one embodiment of the creation of a face molding using thermal plastic meshes for use with a wearable tactile stimulation device.

FIG. 4 depicts one embodiment of a facial mask of a wearable tactile stimulation device with embedded nozzles and conduits.

FIG. 5 depicts one embodiment of an air-suit of a wearable tactile stimulation device with embedded conduits.

FIG. 6 depicts a person on an MRI table wearing a wearable tactile stimulation device comprising a facial mask with embedded nozzles and conduits and an air suit.

FIG. 7 depicts one embodiment of 64 channel control modules.

FIG. 8 depicts two people wearing complete wearable tactile stimulation devices.

FIG. 9 is a block diagram illustrating one embodiment of an entertainment system.

FIG. 10 is a schematic illustration of one embodiment of an implementation of the entertainment system in a theater.

FIG. 11 is a perspective view of one embodiment of the goggles.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The following patents and patent applications may be relevant to tactile stimulation devices: U.S. Pat. No. 5,201,365, titled “Wearable air conditioners”, issued Apr. 13, 1993; U.S. Pat. No. 6,823,678, titled “Air conditioner system for flexible material-based devices”, issued Nov. 30, 2004; U.S. Publication No. 2010/0236267, titled “Wearable personal air conditioning system”, published Sep. 23, 2010; U.S. Pat. No. 5,220,921, titled “Nonmagnetic tactile stimulator and biomagnetometer utilizing the stimulator”, issued Jun. 22, 1993; U.S. Pat. No. 6,757,916, titled “Pressure applying garment”, issued Jul. 6, 2004; U.S. Publication No. 2005/0080366, titled “Pneumatic stimulator array”, published Apr. 14, 2005; U.S. Pat. No. 7,721,357, titled “Wearable air bag device”, issued May 25, 2012; U.S. Publication No. 2007/0063849, titled “Wearable haptic telecommunication device and system”, published Mar. 22, 2007; U.S. Publication No. 2008/0153590A1, titled “Tactile wearable gaming device”, published Jun. 26, 2008; U.S. Publication No. 2009/0234256, titled “Portable air pulsator and thoracic therapy garment”, published Sep. 17, 2009; U.S. Publication No. 2010/0256540, titled “Body surface compression with pneumatic shortening element”, published Oct. 7, 2010; U.S. Pat. No. 4,779,615, titled “Tactile stimulator”, issued Oct. 25, 1988; U.S. Pat. No. 5,165,897, titled “Programmable tactile stimulator array system and method of operation”, issued Nov. 24, 1992; U.S. Publication No. 2006/0015045, titled “Method and apparatus for generating a vibrational stimulus”, published Jan. 19, 2006; U.S. Publication No. 2006/010921, titled “Wearable apparatus for converting vision signal into haptic signal”, published May 25, 2006; U.S. Publication No. 2010/0134327, titled “Wireless haptic glove for language and information transference”, published Jun. 3, 2010; U.S. Pat. No. 5,022,407, titled “Apparatus for automated tactile testing”, issued Jun. 11, 1991; U.S. Pat. No. 5,035,242, titled “Method and apparatus for sound responsive tactile stimulation of deaf individuals”, issued Jul. 30, 1991; U.S. Pat. No. 5,583,478, titled “Virtual environment tactile system”, issued Dec. 10, 1996; U.S. Publication No. 2005 0132290, titled “Transmitting information to a user's body”, published Jun. 15, 2005; U.S. Publication No. 2007/0030246, titled “Tactile feedback man-machine interface device”, published Feb. 8, 2007; U.S. Publication No. 2008/0120029, titled “Wearable tactile navigation system”, published May 22, 2008; U.S. Publication No. 2010/0030123, titled “Vibrotactile devices for controlled somatosensory stimulus during fMRI”, published Feb. 4, 2010; U.S. Publication No. 2010/0238005, titled “System and Apparatus for silent pulsating communications”, published Sep. 23, 2010; and U.S. Publication No. 2010/0278512, titled “Node structure for representing tactile information”, published Nov. 4, 2010.

Some embodiments disclosed herein relate to a wearable tactile stimulation device (“WTSD”). In some embodiments, a WTSD can allow high-density and high-count (128 locations and up) stimulation anywhere on the skin surface. Some aspects of a wearable tactile stimulation device allow reliable, precise, and localized stimulation to be set up in a short period of time. In some aspects, a wearable tactile stimulation device is compact, light-weight and portable. In some aspects, a wearable tactile stimulation device includes air-control modules that are stackable, cascadable, and expandable. In some aspects, modules of a wearable tactile stimulation device and each module can be stand-alone or combined with other modules. In some embodiments, the control module can be connected to a wearable receptacle that is worn on or over some portion of a subject's body.

In some embodiments, the air-control modules can be wired and/or wirelessly connected with one or several processors and/or computers. In some embodiments, the timing and locations of stimulation can be programmed and flexibly reconfigured. Such capabilities can, for example, allow the possibility of telehealth services, such as, for example the remote delivery of a sensory stimulation sequence and remote monitoring of motor responses. In some embodiments, the internet can be used for remote delivery of sensory stimulation sequences and remote monitoring of motor responses.

Some embodiments relate to a non-invasive wearable tactile stimulation device (WTSD) for precise tactile stimulation on skin surface. In some embodiments, conduits and nozzles are embedded in clothing (e.g. mask, suit, gloves, and sandals), which allows computer controlled air flow to be delivered to a large number of locations on a small region of skin (i.e. high-density array) or to a widespread range on the full-body surface (from head to toes). Complex spatial-temporal patterns of tactile stimulation across the body can easily be generated by computer programs, and be synchronized with visual and/or auditory stimulation. Users can easily put the “air suit” or “air mask” on themselves or another person, quickly connect the suit or mask to the air-control modules via bundle of tubes and quick connectors, and can be quickly ready for testing and/or use.

In some aspects, a wearable device can be configured for precise non-invasive tactile stimulation on skin surface. Conduits and nozzles can be embedded in clothing such as, for example, glasses, goggles, hats, helmets, headsets, masks, bra, braces, sweater, underwear, sleeves, gloves, pants, shorts, socks, sandals, shoes, necklaces, bands, guards, or any other wearable item. In some embodiments, the clothing or other wearable item can be configured to allow computer controlled air flow to be delivered to a number of locations. In some embodiments, the number of locations that air can be delivered to can be about 1000 locations, 500 locations, 250 locations, 128 locations, 100 locations 64 locations, 20 locations, 10 locations, 5 locations, 1 location, or any number of locations there between. In one embodiment, for example, air can be delivered to a large number of locations on a small region of skin as in a high density array, including, for example, 500 locations on a body part, 200 locations on a body part, 128 locations on a body part, 100 locations on a body part, 64 locations on a body part, 20 locations on a body part, 10 locations on a body part, 5 locations on a body part, 1 location on a body part, or any number there between, or air can be delivered to a widespread range on the full-body surface. In some embodiments, complex spatial-temporal patterns of tactile stimulation across the body or body part can be generated by computer programs, and be synchronized with visual and/or auditory stimulation. In some embodiments, users can put on the ‘air suit’ or other wearable item and connect it to air-control modules via bundle of tubes and quick connectors, i.e. ‘plug and play’.

In one exemplary embodiment, a wearable tactile stimulation device can comprise a 64-channel system. In one embodiment, a 64-channel system can be used for tactile stimulation in fMRI experiments. One embodiment of a wearable tactile stimulation device includes a case configured to contain four modules of 16-channel control boxes and tube bundles. In one embodiment, the case can be a suitcase, and can be configured to hold four modules of 16-channel air control boxes and bundles of 64 tubes.

In one exemplary embodiment of a wearable tactile stimulation device, the wearable tactile stimulation device can include wearable parts, such as, for example, a male air suit, a female air suit, a facial mask, and a pair of gloves or mittens. In some embodiments, the air suit can be configured for body stimulation, the facial mask can be configured for facial stimulation, and the gloves or mittens can be configured for hand and/or figure stimulation.

In some embodiments, the WTSD can provide non-invasive stimulation and probe for rehabilitation for patients affected by stroke, brain tumor, and other conditions affecting the tactile sensory functions. In some embodiments, the WTSD can provide effective brain mapping of multiple body parts for neuroimaging applications. In some embodiments, the WTSD can provide sensory substitution for blind and deaf individuals. In some embodiments, the WTSD can provide tactile feedback for human computer interaction, video game, virtual reality, remote social interaction, and silent communication. In some embodiments, the WTSD can provide “multisensory” entertainment applications. In some embodiments, the spatial-temporal sequence of tactile stimulation can be synchronized with music or a movie. In some embodiments, the device is compatible with many clinical and research environments including MRI/MEG/PET/CT. In some embodiments, the device can be used as sensory substitution for the blind and deaf population. In some embodiments, the WTSD can allow reliable, precise, and localized stimulation. The WTSD can be compatible with imaging modalities including MRI, MEG, EEG, NIRS, PET, and CT.

### Facial Mask and Air Suit

Custom facial masks and air suits can be designed to precisely guide the locations of air-puff stimuli on the face and body. A mask can be molded on the right-half (For example, 16 points) or full (For example, 32 points) face of each subject using thermal plastic meshes. In some embodiments, a total of 64 1/16-inch conduits and right-angle nozzles can be embedded in the mask and suit, which delivered air puffs to the face, neck, shoulder, upper arm, elbow, lower arm, wrist, hands, torso, legs, feet, toes, fingers, and finger tips.

In some embodiments, a WTSD can be a wearable air receptacle configured to be worn over at least a portion of a subject's body. In some further embodiments, a WTSD can be configured to receive a plurality of air delivery components. These components can direct air to at least a portion of said wearable air receptacle.

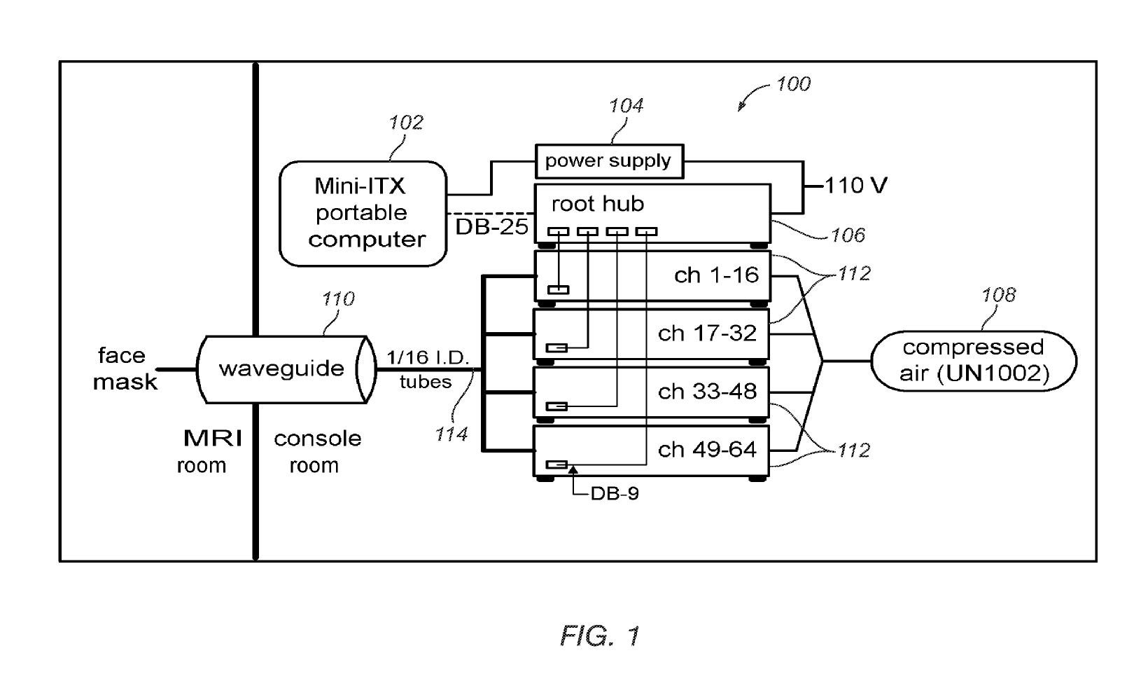

FIG. 1 depicts one embodiment of a WTSD system 100. The WTSD system 100 can include a controller 102, such as, for example, a Mini-ITX portable computer, or any other computer. The controller 102 can be configured to control air flowing to the wearable module. In some embodiments, this can include, for example, sending control signals to modules of the WTSD system 100. In some embodiments, the controller 102 can comprise a processor and memory comprising stored instructions configured to direct the operation of the WTSD system 100.

As further depicted in FIG. 1, the WTSD system 100 can further comprise a power supply 104 configured to provide power to the WTSD system 100, a root hub 106, and a compressed air supply 108 configured to provide pressurized air to the WTSD system 100.

In some embodiments, and as shown in FIG. 1, the root hub 106 can be connected to a plurality of channel controllers 112. As specifically depicted in FIG. 1, the root hub 106 is connected to four channel controllers 112, each of which controls sixteen channels.

As depicted in FIG. 1, the channel controllers 116 can be connected to the waveguide 110 via a plurality of tubes 114. The tubes 114 can be any feature or device configured to direct the flow of a fluid, and can include, for example, a conduit, a hose, a channel, a pipe, a bore, a tunnel, a duct, a vessel, or a canal, and can be integrally formed into other components of the WTSD system 100 or can be an independent component of the WTSD system 100. The tubes 114 can be sized and configured to allow the passage of air puffs. In some embodiments, the tubes can be flexible, and in some embodiments, the tubes can be rigid. In some embodiments, the tubes can be configured to insulate the air to maintain a different temperature in the air than in the surrounding environment. As depicted in FIG. 1, the tubes 114 can have an internal diameter of 1/16 inches. As also depicted in FIG. 1, the tubes 114 can pass through a waveguide 110.

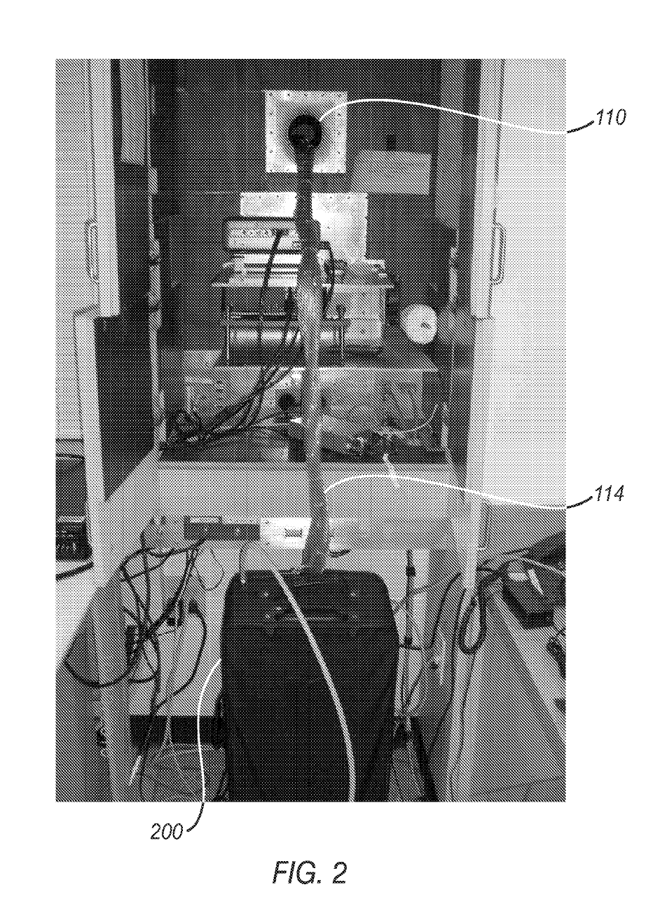

FIG. 2 depicts one embodiment of a portable 64-channel system in a case 200. The case 200 can comprise a variety of shapes and sizes, and can be configured to contain components of the WTSD system 100 such as, for example, one or several channel controllers 112, the controller 102, the power supply 104, the root hub 106, and/or any other desired component of the WTSD system 100. As seen in FIG. 2, the tubes 114 can come from the case 200 and pass to a waveguide 110.

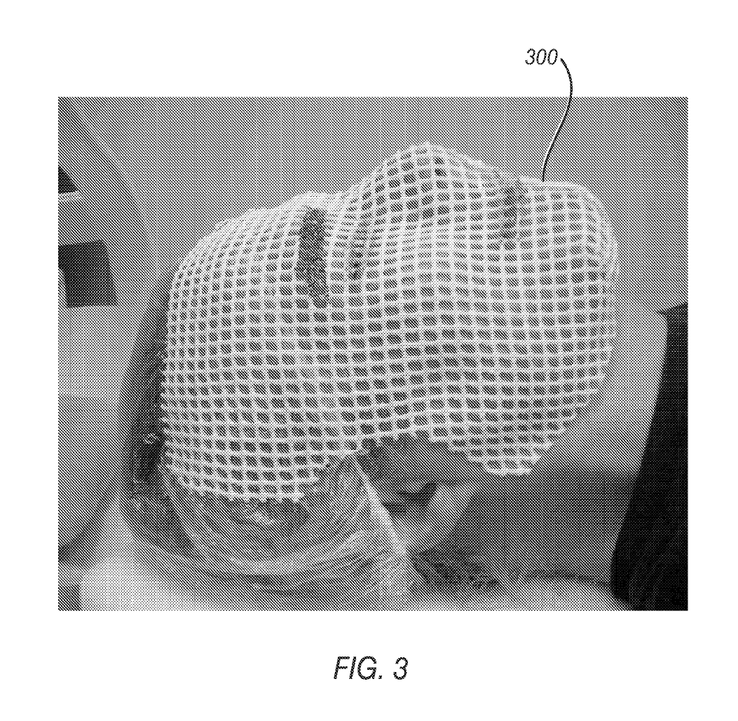

FIG. 3 depicts a face molding 300. In some embodiments, the face molding 300 can be configured to conform with the anatomy of a specific user's face, and or to generally conform to the anatomy of a face. In some embodiments, and as depicted in FIG. 3, the face molding 300 can be custom molded to a specific users face. In some embodiments, the face molding 300 can be used as a component of an air receptacle for being worn on or over a portion of the subject's body. The face molding 300 can be made from a variety of materials, including a natural material, a synthetic material, plastic, polymer, rubber, plaster, and or any other desired material. FIG. 3 depicts one embodiment in which the face molding 300 is made from a thermal plastic mesh.

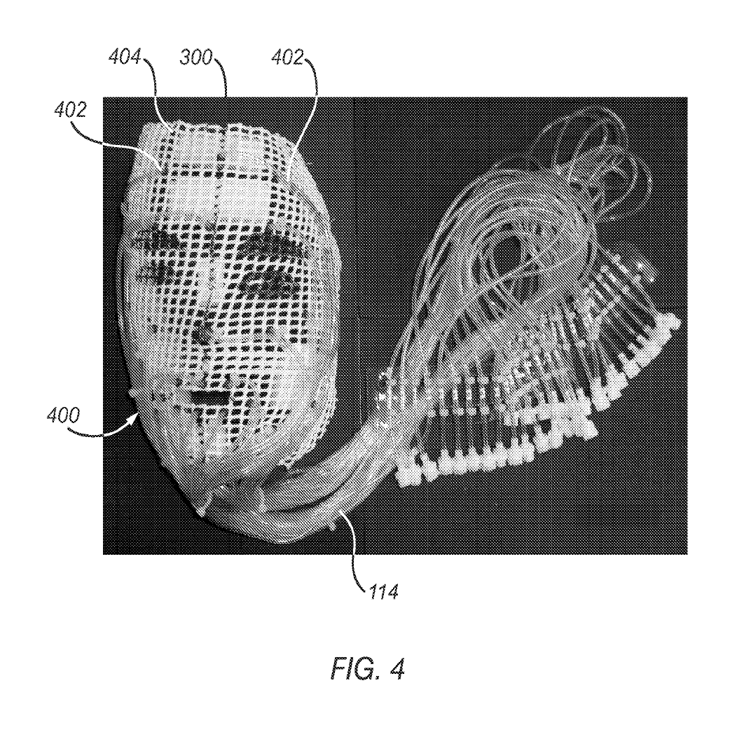

FIG. 4 depicts a facial mask 400 that comprises the face molding 300 configured with embedded tubes 114 and nozzles 402. In some embodiments, the nozzles 402 can comprise an opening in the tube 114 and/or features attached to the tube 114 configured to allow flow of fluid and/or air from the tube 114. The nozzles 402 can include an opening, exit hole, port, pore, exhaust, outlet, ventage, embrasure, aperture, or orifice. A facial mask 400 can be configured with a number of tubes 114 and nozzles 402. In some embodiments, each tube 114 and nozzle 402 can be directed to stimulate a unique portion of the face. The nozzles 402 can be positioned in openings 404 in the face molding 300, and can be directed, for example, at the lips, cheeks, nose, eyes, eye-lids, or any other portion of the face. Additionally, the density of the nozzles 402 in the facial mask 400 can vary. In some embodiments, each tube 114 and nozzle 402 can be directed to stimulate, in coordination with other nozzles 402 and conduits 401, a single portion of a face. A facial mask 400 can be configured to stimulate and desired number and portions of a face.

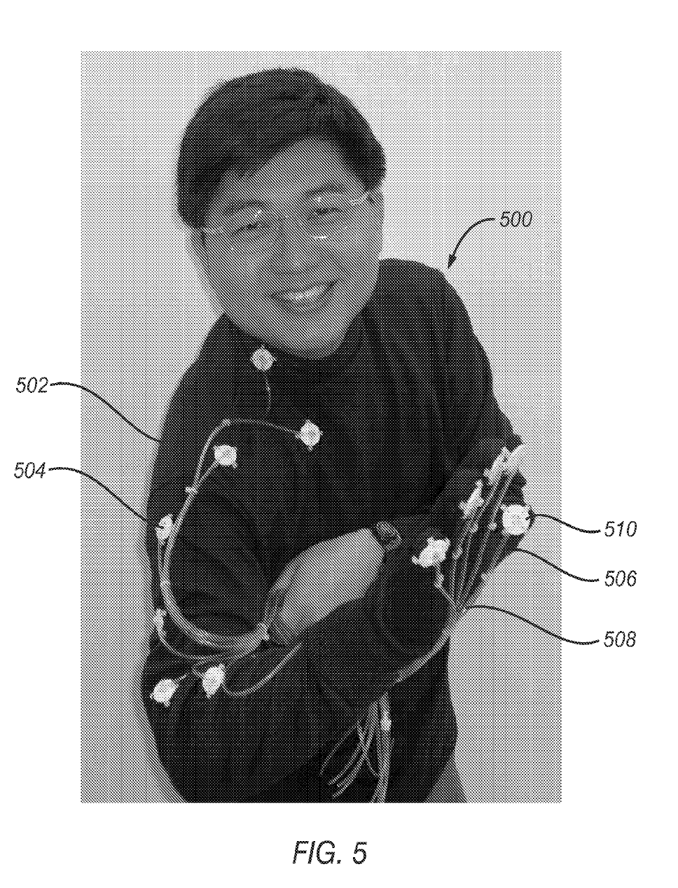

FIG. 5 depicts one embodiment of an air-suit 500 configured with embedded air-suit conduits 502 and air-suit nozzles 504. An air suit can be configured with a desired number of conduits and nozzles. In some embodiments, each air-suit conduit 502 and air-suit nozzle 504 can be directed to stimulate a unique portion of the subject's body. In some embodiments, each air-suit conduit 502 and air-suit nozzle 504 can be directed to stimulate, in coordination with other nozzles and conduits, a single portion of a body. As also depicted in FIG. 5, the air-suit 500 includes a glove 506 including glove conduits 508 and glove nozzles 510 An air-suit 500 can be configured to stimulate any desired number and portions of a body.

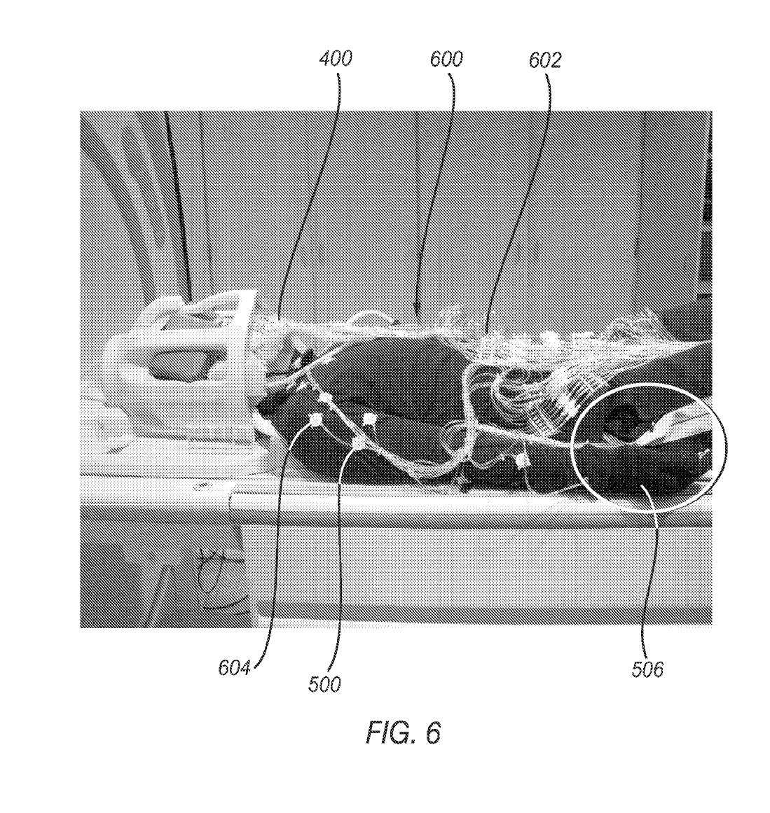

FIG. 6 depicts an individual wearing one embodiment of a WTSD 600. In some embodiments, the WTSD 600 comprises the components of the WTSD system 100 worn by the subject to stimulate portions of the subject body. These can include, for example, a facial mask 400, an air-suit 500, and gloves 506. As seen in FIG. 6, each portion of the WTSD 600 can be configured with a desired number of conduits 602 and nozzles 604 configured to stimulate a portion of the body.

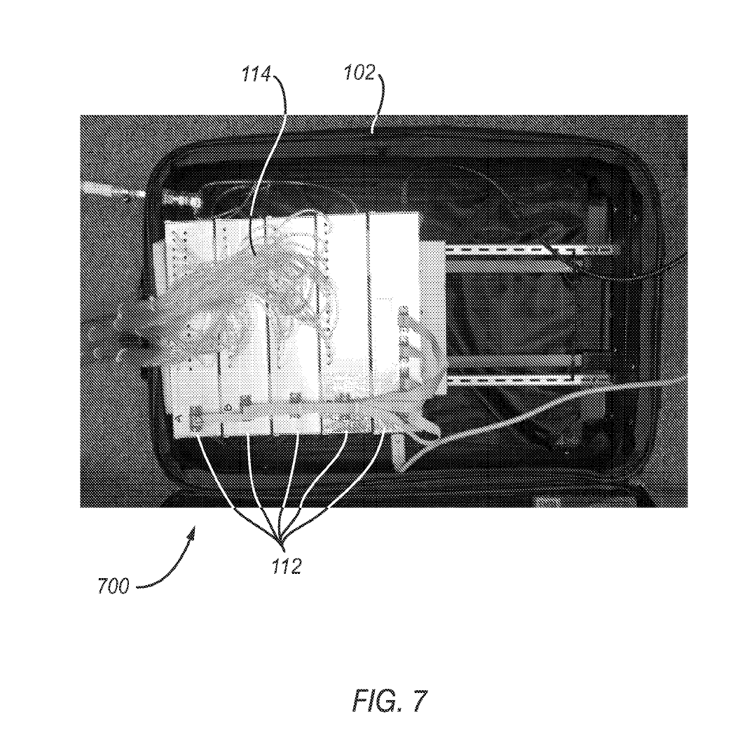

FIG. 7 depicts one embodiment of a 64 channel control module 700. The 64 channel control module 700 can be configured to control up to 64 channels of air flow in the WTSD system 100. As seen in FIG. 7, the 64 channel control module 700 can comprise the controller 102 and one or several of the channel controllers 112. As specifically seen in FIG. 7, the 64 channel control module 700 can comprise four channel controllers 112, each of which can be configured, for example, to control 16 channels of air flow. As seen in the figure, the channel controllers 112 can be connected to tubes 114 and can be connected to the controller 102.

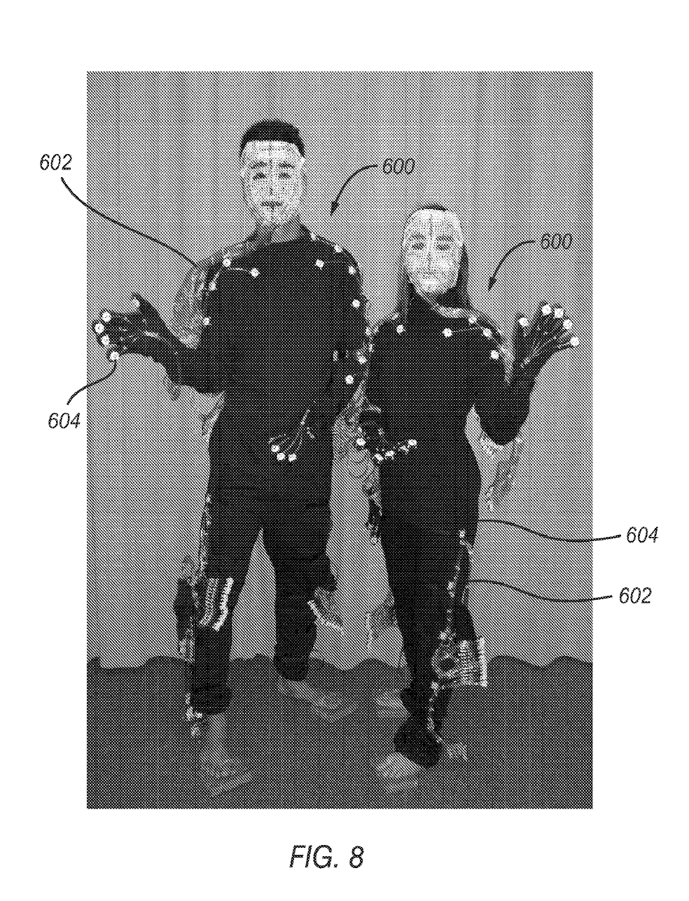

FIG. 8 depicts two subjects wearing complete WTSD's 600. As seen in FIG. 8, the WTSD's 600 provide conduits and nozzles 602, 604 to any desired body part.

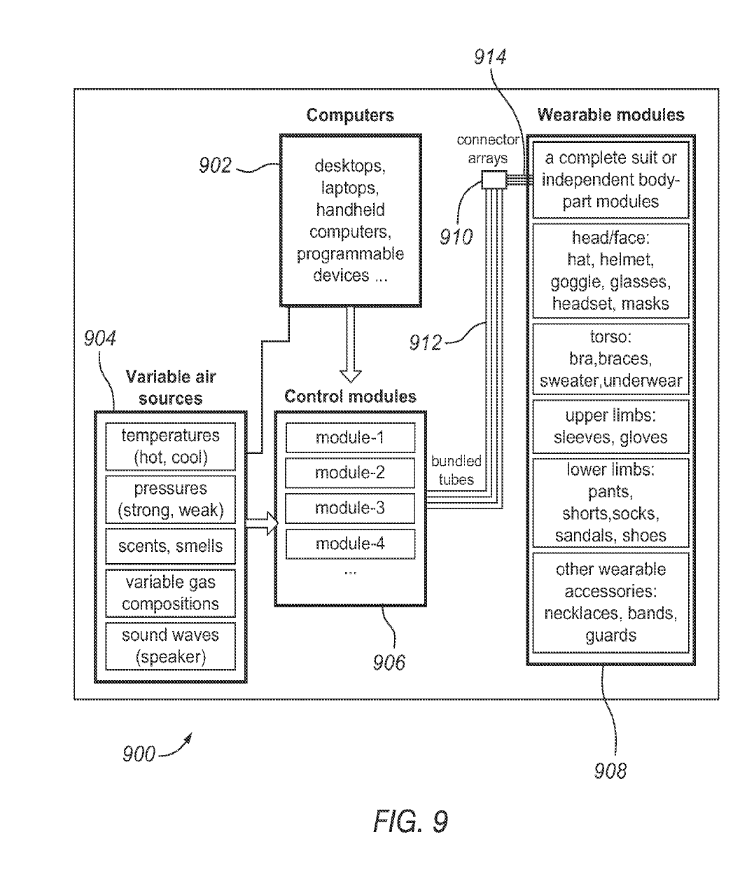

In some embodiments, the WTSD 600 can be used to enhance an entertainment experience, including, for example, the experience watching a movie, watching a television program, playing a video game, listening to music, or any other entertainment experience. In some such embodiments, the WTSD 600 can provide pressurized air to a portion of the subject's body, which pressurized air may correspond to the entertainment. For example, the pressurized air may generate a sensation which corresponds to the sensation that the wearer would experience if the wearer were in the environment represented in the entertainment. FIG. 9 is block diagram illustrating one embodiment of an entertainment system 900 for using a WTSD 600 to enhance an entertainment experience.

The entertainment system 900 can include a computer 902, an air source such as a variable air source 904, one or several control modules 906, one or several wearable modules 908, one or several connector arrays 910, and one or several bundled tubes 912.

The computer 902 can be configured to receive inputs from a user and/or other modules of the entertainment system 900 and to provide outputs to the user and/or to other modules of the entertainment system 900. The computer 902 can comprise a processor and memory including stored instructions that direct the operation of the entertainment system 900. The computer 902 can be any device capable of performing the required control function, and can include, for example, a desktop, a laptop, a handheld device, or a programmable device.

The computer 902 can be in communicating connection with the variable air source 904. The variable air source 904 can be configured to receive control signals from the computer 902 and to supply air based on these control signals. In some embodiments, the variable air source 904 can be configured to manipulate the temperature of the air by, for example, heating or cooling the air, varying the humidity of the air, changing the pressure of the air, add scent to the air, varying the gas composition of the air, and/or propagating sound waves through the air. In some embodiments, for example, the variable air source 904 can comprise a heater, a cooler, a humidifier, a dehumidifier, a pump, a throttle valve, containers of scents, and gas containers.

The variable air source 904 can provide air to the channel controllers 906. The channel controllers 906 can be configured to control the air output to a number of tubes 912. The channel controllers 906 can comprise, for example, valves configured to control the amount, pressure, and duration of air that can pass into the tubes 912. In some embodiments, the valves are connected to a drive that can be, hydraulic, pneumatic, electric, or any other drive type. In some embodiments, the drive can be controlled by a controller located in the channel controllers 906 and/or in the computer 902. The channel controllers 906 can further include sensors configured to sense the valve position, and determine the amount of air flowing past the valve.

The air that travels through the tubes 912 can then pass to the one or several wearable modules 908 through the connector arrays 910 which can be a manifold of connectors that allow quick coupling of wearable module conduits 914. The wearable module conduits 914 can comprise any feature configured to direct the flow of fluid and/or air to a portion of the subject's body. In some embodiments, the wearable module conduits 914 can be integrally formed into the one or several wearable modules 908, and in some embodiments, the wearable module conduits 914 can be attached to the one or several wearable modules 908.

The one or several wearable modules 908 can, as discussed above, be configured to direct air onto or at a portion of the subject's body. The wearable module 908 can comprise, for example, a complete body suit, a plurality of independent modules, a hat, helmet, goggles, glasses, headset, or masks configured for use on the subject's head and/or face, a bra, braces, sweater, and/or underwear configured for use on the subject's torso, sleeves and/or gloves configured for use on the subjects arms, pants, shorts, sock, sandals, and/or shoes configured for use on the subject's legs, and/or a necklace, band, or guard configured for use on other portions of the subject's body. These one or several wearable modules 908 can include, for example, one or several nozzles configured to direct the air to a specific portion of the subject's body, and one or several features configured to receive air from the tubes 912. These features can include, for example, connectors configured to connect with the tubes 912 to place the nozzles in fluid connection with the tubes 912 and thereby the channel controllers 906.

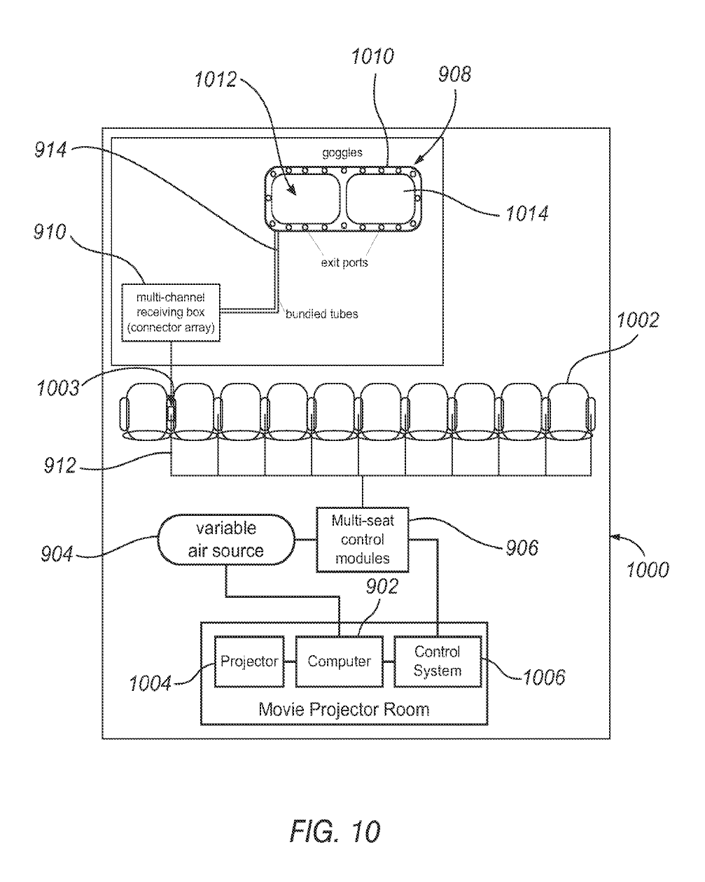

In some embodiments, the entertainment system 900 can be used with other entertainment equipment such as, for example, a television, a computer, a game console, theater, a screen, a studio, a speaker, and amplifier, a handheld device, and/or any other piece of entertainment equipment. FIG. 10 depicts one embodiment in which the entertainment system 900 is used in connection with a movie theater 1000.

The movie theater 1000 can include a variety of components and equipment. As specifically shown in FIG. 10, the theater 1000 can include, for example, the entertainment system 900, including, the computer 902, variable air source 904, the one or several channel controllers 906, the connector array 910, tubes 912, and wearable module conduits 914. In some embodiments, the theater 1000 can further include a screen (not shown). In addition to these features, the theater depicted in FIG. 10 includes seats 1002, a projector 1004, and a control system 1006.

The seats 1002 depicted in FIG. 10 can be configured to allow seating of theater guests during the entertainment, and can include a variety of features. As specifically depicted in FIG. 10, the seats 1002 can include a connector array 910. In some embodiments, the connector array 910 can be located on or proximate to one or several of the seats 1002. As specifically depicted in FIG. 10, the connector array 910 is located on and/or in the armrest 1003 located between the seats 1002.

In some embodiments, the connector array 910 can be connected, physically, fluidly, controllingly, and/or communicatingly, via tubes 912 to the channel controllers 916 and to the variable air source 904, the control system 1006, and the computer 902. As further shown in FIG. 10, in some embodiments, the connector array 910 can be connected to one or several wearable modules 908 via wearable module conduits 914. In some embodiments, the wearable module conduits 914 can be connectable to the connector array 910, and in some embodiments, the wearable module conduits 914 can be an integral component of the connector array 910.

As seen in FIG. 10, in some embodiments, the one or several wearable modules 908 can comprise one or several pairs of goggles 1010. In some embodiments, the goggles 1010 can be configured to be worn on a subject's face and to direct air to specific portions of the subjects face.

In some embodiments, the goggles 1010 can include one or several support features configured to facilitate a subject in wearing the goggles 1010. In some embodiments, these support features can include, for example, an earpiece, a temple, a strap, a band, a nose pad, a bridge, and any other features that help the subject wear the goggles.

In some embodiments, the goggles 1010 can include one or more viewing areas 1012. In some embodiments, the one or more viewing areas 1012 can allow the subject to see when wearing the goggles 1010. In some embodiments, the viewing areas 1012 can comprise a variety of shapes and sizes, and can be located at a variety of positions in the goggles 1010. As seen in FIG. 10, in some embodiments, the viewing areas 1012 can be roughly rectangular.

The viewing areas 1012 can, in some embodiments, include a lens 1014. The lens can be configured to protect the subject while wearing the goggles 1010, to enhance the subject's viewing experience such as by, for example, correcting the subject's vision, providing a stereoscopic effect, and/or filtering passing light.

As seen in FIG. 10, the goggles 1010 can further include a plurality of nozzles 1016. The nozzles 1016 can direct air to a portion of the subject's body, and specifically to a portion of the subject's face. The nozzles 1016 can comprise a variety of shapes and sizes, and can be, for example, circular, ovular, and/or linear. In some embodiments, the shape and size of one of the nozzles 1016 can be selected based on the portion of the subject's body that the nozzle 1016 targets and based on the quantity of air that the nozzle 1016 delivers.

The goggles 1010 can comprise any desired number of nozzles. In some embodiments, the goggles 1010 can comprise 1, 2, 3, 4, 5, 8, 10, 20, 50, 100, and or any other or intermediate number of nozzles. In some embodiments, a single wearable module conduit 914 can be connected to a single nozzle 1016, and in some embodiments, a single wearable module conduit 914 can be connected to a plurality of nozzles 1016.

In some embodiments, the goggles 1010 can include features for connecting the goggles 1010 to the wearable module conduits 914, and in some embodiments, the wearable module conduits 914 can be an integral component of the goggles 1010.

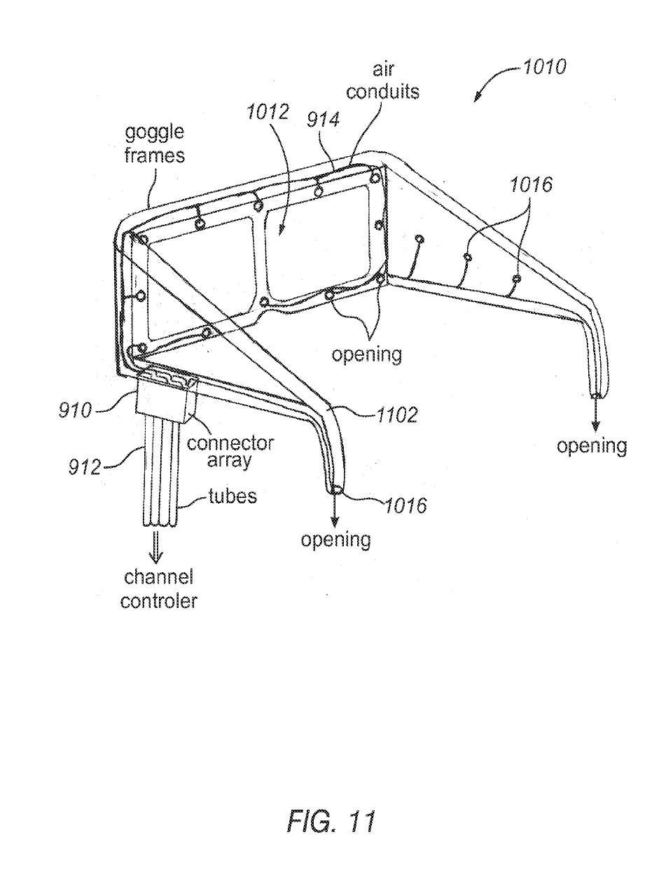

FIG. 11 depicts a perspective view of one embodiment of the goggles 1010. As seen in FIG. 11, goggles 1010 include a connector array 910, a viewing area 1012, a plurality of wearable module conduits 914, and a plurality of nozzles 1016. As seen in FIG. 11, tubes 912 are connected to the goggles 1010 via the connector array 910, which connector array 910 is located on a temple 1102 of the goggles 1010. As also seen in FIG. 11, the wearable module conduits 914 connect the nozzles 1016 to the connector array 910, and thereby allow air and/or fluid to flow from the tubes 912 to the nozzles 1016. As further seen in FIG. 11, the nozzles 1016 can be located in a variety of positions on the goggles 1010, including, for example, around the viewing areas 1012 and on the temples 1102.

A person of skill in the art will recognize that the entertainment system 900 can be used with a variety of features and components and in a variety of settings, and that the present disclosure is not limited to the above specifically enumerated embodiments.

### EXAMPLES

### Experimental Setup

Patches of soft foam padding can be used to support the mask over the face, and 3M Transpore tapes can be used to stabilize the mask. Foam padding can be inserted between the mask and coil to minimize head motion. Computer-controlled lines of air puffs (50-100 ms; compressed air at 25-50 psi out of the regulator) can be delivered to the body surface via 64 25-ft tubes ( 1/16-in I.D.) running through the waveguide. In one embodiment, a subject wearing a WTSD can be instructed to close their eyes in complete darkness during the entire session and can be instructed to attend to the locations and irregularity of air puffs without making overt responses. The hisses of air puffs can be masked by white noise radio delivered via MR-compatible headphones and inside which subjects also wore ear plugs.

### Use in Finding Somatosensory Area Boundaries in Humans

Sensory cortical areas preserve topological relations among sensory inputs. In human visual cortex, ‘phase-encoded’ fMRI retinotopic mapping has revealed many areas. A stimulus is slowly and repeatedly swept across the retina while continuously imaging the brain. To efficiently sample a retinotopic map, only one coordinate is interrogated at a time. For example, a wedge can be slowly swept around 360 degrees to map polar angle; but it always stimulates multiple eccentricities. By combining two 1-D maps, areal borders can be outlined by distinguishing mirror and non-mirror image representations using the field sign method. However, 2-D mapping has rarely been attempted and the number of subdivisions remains unclear. High-density tactile stimulation equipment can be used to generate 2-D somatotopic maps of multiple somatosensory areas in humans. In one embodiment, a device for use in such testing can be configured with 64-channels. For facial stimuli, a mask can be first molded to one side of a subject's face using a thermal plastic mesh. Computer-controlled lines of air puffs (50-100 ms, 25-50 psi) can be slowly and repeatedly swept across the face in one direction at a time using two-dimensional arrays of 1/16-inch air tubes and nozzles bound to the mesh. The mesh mask can be suspended just above the face. Similar stimuli can be delivered to the hand, arm, shoulder and neck. Block-design experiments can be used to assess overall response regions, laterality, and pattern sensitivity. Air puff hisses can be masked by white noise while subjects simply attended the stimuli or monitored for occasional repeats or longer puffs, always with eyes closed in the dark. Standard gradient echo EPI images can be collected (GE 3T, B- and 32-channel RF coils; Siemens 1.5T, 20- or 32-channel RF coil), analyzed with surface-based methods (FreeSurfer, AFNI), and rendered on inflated surfaces reconstructed from high resolution (0.75mm̂3) anatomical data sets.

### Tests Using a WTSD

A WTSD was used in tests. The test included (a) 16-s ON (random or sequential air puffs on one region) vs. 16-s OFF. The test also included (b) 16-s random or sequential air puffs on region A (e.g. face) vs. 16-s air puffs on region B (e.g. fingers).

The test included phase-encoded paradigms. Using a half-face mask, these included, (a) Top→Down (or Bottom→Up): air puffs were randomly delivered to four points in one row of an array for 16 s, and to the adjacent row in the next 16-s period and so on. Each 512-s scan contained 8 cycles of sweeping (forehead to chin) on the right face. (b) Nasal→Temporal (Left→Right) or Temporal→Nasal (Right→Left):transpose of array in (a). Using a full-face mask, included, (c) Each 512-s scan contained 8 cycles of air puffs sweeping clockwise or counterclockwise on 14 points around the face.

### Imaging Parameters

Testing was done on a MRI system having a GE 3T Signa Excite, 8-channel head coil; BUCNI (UCL/Birkbeck): Siemens 1.5T Avanto, 32-channel head coil.

The functional sequences included a GE 3T: single shot EPI, 1953 Hz/pixel, flip=90 deg, TE=30 ms, TR=2 s, 3.125×3.125×3.5 mm voxels, 31 slices, 128 or 256 images per slice, 256 s or 512 s per scan; BUCNI Siemens 1.5T: EPI (same except 1474 Hz/pixel, TE=39 ms, 3×3×3 mm voxels, 24 slices).

The structural images included 1 mm³ (GE: FSPGR); 0.75 mm³ (Siemens: MP-RAGE).

### Data Analysis

fMRI data were analyzed using AFNI, Fourier transform, surface-based methods. Significant activations at the stimulus frequency (8 or 16 cycles/scan) and their phases were rendered onto inflated cortical surfaces reconstructed from each subject's structural scans using FreeSurfer.

### Results

Testing described above, resulted in (ON vs. OFF; Region A vs. Region B) multiple representations of the right face/lips/fingers/shoulder in S-I, in the lateral sulcus (PV, S-II, 7b), in parietal cortex (VIP+, AIP), in middle temporal cortex (MST+), and in motor and premotor cortex (PZ, PMv) of the left hemisphere. ‘Center-surround’ stimuli revealed that VIP+prefers the periphery of the face. Preliminary evidence suggested a homunculus map (fingers/lips/face/shoulder) in the superior and anterior part of post-central sulcus.

Phased-encoded scans revealed complete (forehead→cheek→chin) or partial somatotopy in face areas. Area S-I contains at least two contralateral representations, with a phase reversal occurring at their congruent border, i.e. forehead→cheek→chin→chin→cheek→forehead. Areas VIP+contains at least two subdivisions, also showing a phase reversal at their border, i.e., chin→cheek→forehead→forehead→cheek→chin. A tighter X-Y grid of stimulated sites concentrating on the side of the face and including the lips was also run to avoid unintended ‘off-the-edge’ suppression of the lip representation (cf. artifactual activations as the stimulus moves away from the border Sereno and Tootell, 2005).

By combining maps across two 2-D scans, we obtained approximations of 2-D coordinates (X-axis: nasal to temporal; Y-axis: chin to forehead) of face representations in areas S-I and VIP+. Field sign maps suggest face and finger representations contain at least two subdivisions.

The technology is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system may be used in connection with various operating systems such as Linux®, UNIX®, Microsoft Windows®, or Max OS®.

The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

1. A wearable module configured to direct air toward a subject's body, the wearable module comprising:
a plurality of conduits; and
a plurality of openings connected with the conduits, wherein the openings are configured to receive pressurized air from the conduits and direct the pressurized air toward at least a portion of the subject's body, wherein the air is selectively delivered to a subset of the openings.

2. The wearable module of claim 1, further comprising a viewing area.

3-7. (canceled)

8. The wearable module of claim 2 wherein the viewing area comprises a first lens and a second lens configured to provide a stereoscopic effect.

9-10. (canceled)

11. The wearable module of claim 1, wherein the wearable module comprises eyewear.

12-13. (canceled)

14. The wearable module of claim 1, wherein the wearable module is fluidly connected to an air source controlled by a processor configured to execute a set of instructions that will perform a method comprising:
releasing compressed air to a plurality of conduits and openings in a pre-determined pattern.

15. The wearable module of claim 14, the method further comprising:
coordinating the pattern with audiovisual entertainment.

16-20. (canceled)

21. An entertainment system comprising:
an entertainment source;
an air source; and
a wearable module in fluid connection with the air source and configured to receive air from the air source and direct air toward a portion of a subject's body.

22. The system of claim 21, wherein the wearable module comprises a plurality of openings.

23. The system of claim 22, wherein the openings are configured to receive pressurized air from the wearable module via at least one conduit and direct the pressurized air toward a portion of the subject's body.

24. The system of claim 21, wherein the wearable module is configured to be worn over the subject's eyes.

25. The system of claim 21, wherein the wearable module comprises a viewing area.

26-27. (canceled)

28. The system of claim 25 wherein the viewing area comprises a first lens and a second lens configured to provide a stereoscopic effect.

29. The system of claim 21, wherein the wearable module comprises eyewear.

30-43. (canceled)

44. The system of claim 21, wherein the air source provides air to stimulate sensations the subject would experience in the environment represented by the entertainment.

45-92. (canceled)

93. The wearable module of claim 14, wherein the processor is configured to be controlled wirelessly.

94. The System of claim 21, wherein the wearable module comprises eyewear coupled with a plurality of openings and conduits, wherein the openings are configured to receive the air from the air source via the conduits and direct the air to toward the portion of the subject's body, the system further comprising:
a processor configured to execute a set of instructions that will perform a method comprising:
selectively releasing air from the air source to the conduits and openings in a pre-determined pattern; and
coordinating the pattern with audiovisual entertainment.

95. A method of providing tactile stimulation to a subject experiencing audiovisual entertainment and wearing a module according to claim 94 comprising eyewear with a plurality of conduits and openings connected to an air source, the method comprising:
delivering the air from the air source to the plurality of conduits and openings in the eyewear according to claim 94; and
releasing the air in a pre-determined pattern through the plurality of openings and toward the subject, wherein the pattern is coordinated with the entertainment.

96. Eyewear comprising a plurality of openings connected to a plurality of conduits, wherein the conduits are configured to be fluidly connected to an air source.

97. The wearable module of claim 11, wherein the eyewear is selected from the group consisting of glasses and goggles.

98. The wearable module of claim 29, wherein the eyewear is selected from the group consisting of glasses and goggles.
